(19) United States
(12) Patent Application Publication
(10) Pub. No.: US 2026/0054924 A1
(43) Pub. Date: Feb. 26, 2026

(54) High-transmission-performance four-way shuttle and a working method thereof

(71) Applicant: Bullseye Intelligent Logistics Equipment (Suzhou) Co., Ltd., Suzhou (CN)

(72) Inventors: Jian Shen, Suzhou (CN); Libin Kuai, Suzhou (CN); Youcai Shen, Suzhou (CN); Xiangming Wang, Suzhou (CN); Linhua Chen, Suzhou (CN)

(21) Appl. No.: 19/174,695

(22) Filed: Apr. 9, 2025

(30) Foreign Application Priority Data
Aug. 26, 2024 (CN) 202411170325.4

(51) Int. Cl. B65G 1/04; B61C 9/48

(52) U.S. Cl. CPC B65G 1/0492; B61C 9/48

(57) ABSTRACT

A high-transmission-performance four-way shuttle and its working method. The shuttle comprising two X-direction travel gearboxes and two Y-direction travel gearboxes; each X-direction travel gearbox is connected to both Y-direction gearboxes; four travel gearboxes form a square shape. Using an X-direction or Y-direction travel servo motor planetary reducer to drive an X-direction or Y-direction travel drive shaft to rotate through an X-direction or Y-direction travel gearbox, the four-way shuttle drives load to move in X-direction or Y-direction, avoiding the tedious regular tensioning and maintenance brought by chain transmission.

### FIELD OF THE INVENTION

The present invention relates generally to warehousing logistics equipment, and more specifically, it relates to high-transmission-performance four-way shuttle and a working method thereof.

### DESCRIPTION OF THE RELATED ART

Any discussion of the prior art throughout the specification should in no way be considered as an admission that such prior art is widely known or forms part of common general knowledge in the field.

In the daily operation of warehousing and logistics, more and more factories use integrated automation systems that combine shuttles with shelves to replace traditional warehousing and logistics operations, and the four-way shuttle is particularly outstanding for its higher construction economy.

Previously, when a four-way shuttle was in use, its travel system usually adopted multi-wheel drive travel. The conventional travel system on the market is often used to achieve power transmission through chain transmission, which has certain disadvantages. After long-term use, the chain transmission causes the chain to loosen, and operators need to regularly tighten and maintain the chain, causing great cumbersomeness to the operators and increasing the labor cost. Therefore, a solution to alleviate the above problems is urgently needed.

### BRIEF SUMMARY OF THE INVENTION

In view of the foregoing disadvantages inherent in the previous disclosure, the present invention provides high-transmission-performance four-way shuttle and a working method thereof.

The high-transmission-performance four-way shuttle comprises two X-direction travel gearboxes and two Y-direction travel gearboxes; the four travel gearboxes form a square shape, with the two X-direction travel gearboxes positioned opposite each other and the two Y-direction travel gearboxes positioned opposite each other; an X-direction travel servo motor planetary reducer is installed to one of the two X-direction travel gearboxes; an X-direction drive shaft is installed inside one of the two X-direction travel gearboxes; X-direction travel wheels are installed to the X-direction travel drive shaft; a Y-direction travel servo motor planetary reducer is installed to one of the two Y-direction travel gearboxes; a Y-direction drive shaft is installed inside one of the two X-direction travel gearboxes; Y-direction travel wheels are connected to the X-direction travel drive shaft.

Preferably, the Y-direction travel servo motor planetary reducer is fixedly connected to a lifting and reversing servo motor planetary reducer; and a lifting and reversing drive shaft is installed inside the lifting and reversing servo motor planetary reducer.

Preferably, a lifting and reversing gearbox is installed to the lifting and reversing drive shaft; and a cam swing arm is installed to the lifting and reversing gearbox.

Preferably, an X-direction guide slider is slidably connected to the cam swing arm; the X-direction guide slider is fixedly connected to the X-direction gearboxes and the Y-direction gearboxes.

Preferably, the four-way shuttle includes four Y-direction travel wheels and two Y-direction travel drive shafts.

Preferably, the Y-direction travel drive shaft has two ends; with each end connected to Y-direction travel wheels, and the number of X-direction travel wheels is four.

Preferably, the four-way shuttle includes two X-direction travel drive shafts; with each X-direction travel drive shaft having two ends, and each end is installed with X-direction travel wheels.

It further provides a method for operating the four-way shuttle with high transmission performance:
S1: An X-direction travel servo motor planetary reducer is started, which drives an X-direction travel drive shaft through an X-direction travel gearbox; this causes the X-direction travel drive shaft to drive X-direction travel wheels to rotate and roll along an X-direction track, enabling the four-way shuttle to transport along the X-direction track;
S2: A lifting and reversing servo motor planetary reducer is started, which drives a lifting and reversing drive shaft through a lifting and reversing gearbox; this causes the lifting and reversing drive shaft to move a cam swing arm along an X-direction guide slider, lifting the cam swing arm; the cam swing arm then pushes X-direction travel wheels and Y-direction travel wheels into position, enabling Y-direction travel wheels to make contact with a Y-direction track;
S3: A Y-direction travel servo motor planetary reducer is started, which drives a Y-direction travel drive shaft through a Y-direction travel gearbox; this causes the Y-direction travel drive shaft to drive Y-direction travel wheels to rotate and roll along the Y-direction track, enabling the four-way shuttle to transport along the Y-direction track.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in drawings. The invention is capable of other embodiments and of being practiced and carried out in various ways. Also, it is to be understood that the phraseology and terminology employed herein are for the purpose of the description and should not be regarded as limiting.

Compared with the prior disclosure, the present disclosure has the following advantages.

First, the Y-direction travel servo motor planetary reducer and X-direction travel servo motor planetary reducer drive the Y-direction travel shaft and X-direction travel shaft through Y-direction travel gearbox and X-direction travel gearbox, so that the Y-direction travel wheel and X-direction travel wheel roll and drive the goods to move forward in Y-direction and X-direction, eliminating the cumbersome regular tightening maintenance caused by the chain transmission. Second, the lifting and reversing motor planetary reducer drives the cam swing arm to move in one single direction, so that the movement of the cam swing arm be consistent and the direction be changed stably, eliminating the phenomenon of hydraulic lifting and asynchronism. The present invention does not rely on electronic control or software programs, and can effectively prevent falling or deviation caused by overloading of the lifting and reversing mechanism when problems with the hydraulic cylinder lifting occur due to network communication signals, software program loopholes, etc., so as to accurately position the walking wheels and avoid economic losses and casualties.

To the accomplishment of the above and related advantages, this disclosure may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the present invention.

FIG. 2 is a top view of the present invention.

FIG. 3 is a side view of the present invention.

FIG. 4 is another side view of the present invention.

### DETAILED DESCRIPTION OF THE INVENTION

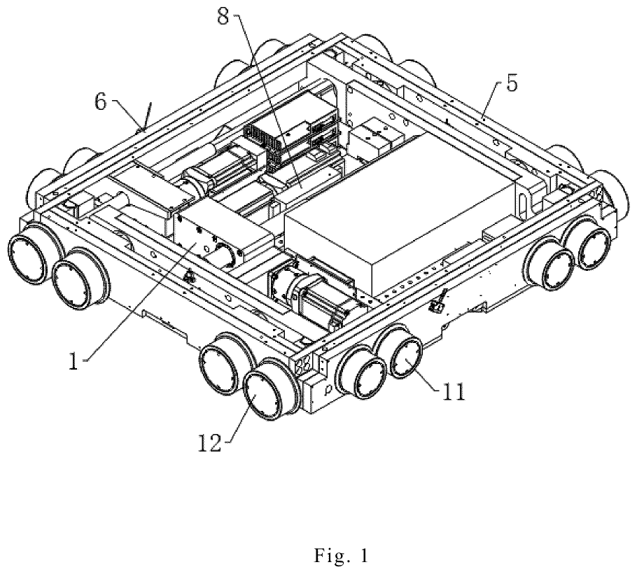

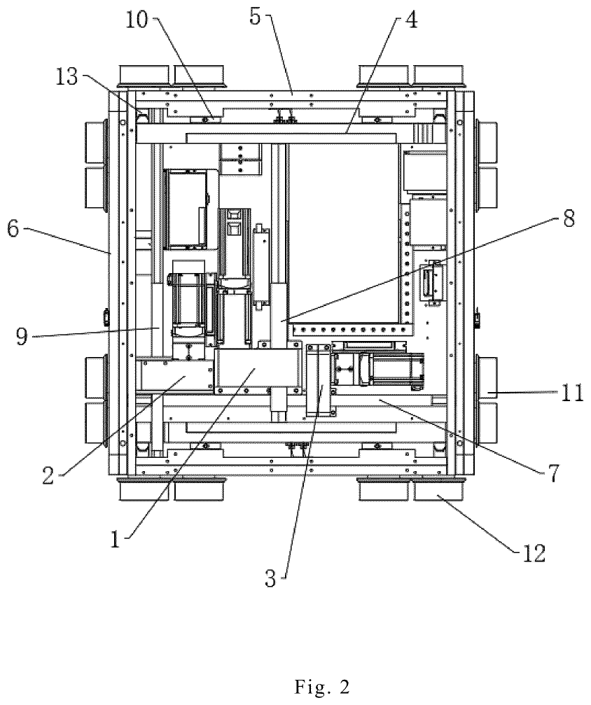

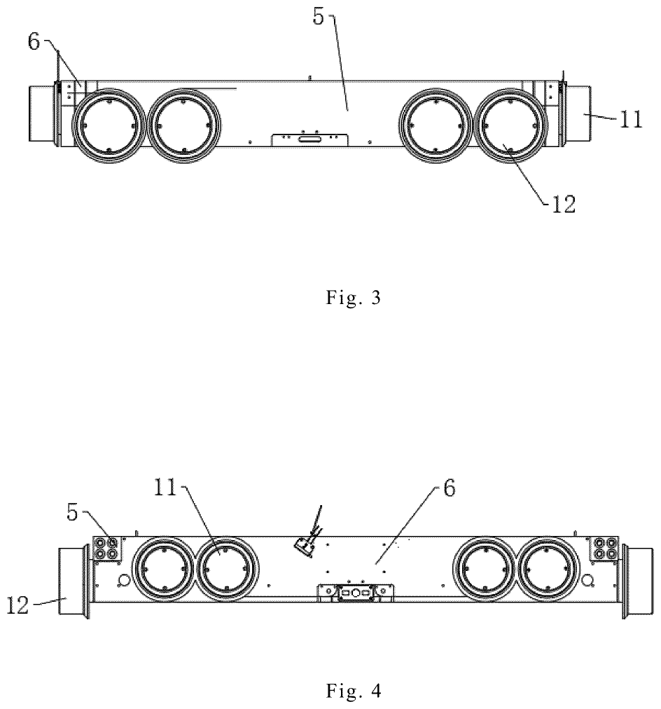

Turning now descriptively to the drawings, in which similar reference characters denote similar elements throughout the several view, FIGS. 1 through 4 illustrate high-transmission-performance four-way shuttle, which comprises two X-direction travel gearboxes 5 and two Y-direction travel gearboxes 6; the four travel gearboxes form a square shape, with the two X-direction travel gearboxes 5 positioned opposite each other and the two Y-direction travel gearboxes 6 positioned opposite each other; an X-direction travel servo motor planetary reducer 3 is connected to one of the two X-direction travel gearboxes 5; an X-direction drive shaft 9 is installed inside one of the two X-direction travel gearboxes 5; an X-direction travel wheel 12 is connected to the X-direction travel drive shaft 9; a Y-direction travel servo motor planetary reducer 2 is connected to one of the two Y-direction travel gearboxes 6; a Y-direction drive shaft 7 is installed inside one of the two X-direction travel gearboxes 6; a Y-direction travel wheel 11 is connected to the X-direction travel drive shaft 7.

The Y-direction travel servo motor planetary reducer 2 is fixedly connected to a lifting and reversing servo motor planetary reducer 1; and a lifting and reversing drive shaft 8 is installed inside the lifting and reversing servo motor planetary reducer 1. A lifting and reversing gearbox 4 is installed to a side of the lifting and reversing drive shaft 8; and a cam swing arm 10 is installed to a side of the lifting and reversing gearbox 4. An X-direction guide slider 13 is slidably connected with the cam swing arm 10; the X-direction guide slider 13 is fixedly connected to the X-direction travel gearboxes 5 and the Y-direction travel gearboxes 6. The number of Y-direction travel wheels 11 is four, and the number of Y-direction travel drive shafts 7 is two. The number of X-direction travel wheels 12 is four, and the number of X-direction travel drive shafts 9 is two. Each X-direction travel drive shaft 9 having two ends, and each end is installed with X-direction travel wheels 12. Each Y-direction travel drive shaft 7 has two ends, with each end connected to Y-direction travel wheels 11.

During operation, the X-direction travel wheels 12 and Y-direction travel wheels 11 are placed on the X-direction and Y-direction tracks, ensuring that the X-direction travel wheels 12 make contact with the X-direction track.

When movement is required in the X-direction, the X-direction travel servo motor planetary reducer 3 is first activated. This causes the X-direction travel servo motor planetary reducer 3 to drive the X-direction travel gearbox 5, which in turn rotates the X-direction travel drive shaft 9. As a result, the X-direction travel drive shaft 9 drives the X-direction travel wheels 12 to rotate, making them roll along the X-direction track, allowing the system to move goods along the X-direction track on the shelving unit.

Each Y-direction travel drive shaft 7 is connected to a Y-direction travel wheel 11 at both ends. There are four sets of X-direction travel wheels 12 and two sets of X-direction travel drive shafts 9, with each X-direction travel drive shaft 9 connected at both ends to its respective X-direction travel wheels 12.

At this point, the lifting and switching servo motor planetary reducer 1 is activated, which drives the lifting and switching gearbox 4 to rotate the lifting and switching drive shaft 8. This, in turn, moves the cam swing arm 10, causing it to slide along the X-direction guide slider 13 and lift upwards. As a result, the cam swing arm 10 pushes the X-direction travel wheels 12 and Y-direction travel wheels 11 to move, bringing the Y-direction travel wheels 11 into contact with the Y-direction track.

Next, the Y-direction travel servo motor planetary reducer 2 is activated, which drives the Y-direction travel gearbox 6 to rotate the Y-direction travel drive shaft 7. This rotation drives the Y-direction travel wheels 11, causing them to roll along the Y-direction track. As a result, the system moves goods along the Y-direction track, enabling movement in both the X-direction and Y-direction.

The present invention also discloses a method for operating the four-way shuttle with high transmission performance, comprising three steps:
S1: The X-direction travel servo motor planetary reducer 3 is started, driving the X-direction travel drive shaft 9 to rotate through the X-direction travel gearbox 5; the X-direction travel drive shaft 9 in turn drives the X-direction travel wheels 12 to rotate, enabling movement along X-direction track;
S2: The lifting and reversing servo motor planetary reducer 1 is started, driving the lifting and reversing drive shaft 9 through the lifting and reversing gearbox 5; the lifting and reversing drive shaft 9 drives the cam swing arm 10 to move along the X-direction guiding block 13, pushing both the X-direction travel wheels 12 and the Y-direction travel wheels 11, bringing the Y-direction travel wheels 11 into contact with a Y-direction track;
S3: The Y-direction travel servo motor planetary reducer 2 is started, driving the Y-direction travel drive shaft 7 to rotate through the Y-direction travel gearbox 6; the Y-direction travel drive shaft 7 drives the Y-direction travel wheel 11 to rotate and enabling movement along Y-direction track.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A high-transmission-performance four-way shuttle, comprising two X-direction travel gearboxes and two Y-direction travel gearboxes; the four travel gearboxes form a square shape, with the two X-direction travel gearboxes positioned opposite each other and the two Y-direction travel gearboxes positioned opposite each other; an X-direction travel servo motor planetary reducer is installed to one of the two X-direction travel gearboxes; an X-direction drive shaft is installed inside one of the two X-direction travel gearboxes; X-direction travel wheels are installed to the X-direction travel drive shaft; a Y-direction travel servo motor planetary reducer is installed to one of the two Y-direction travel gearboxes; a Y-direction drive shaft is installed inside one of the two X-direction travel gearboxes; Y-direction travel wheels are connected to the X-direction travel drive shaft.

2. The high-transmission-performance four-way shuttle in claim 1, wherein the Y-direction travel servo motor planetary reducer is fixedly connected to a lifting and reversing servo motor planetary reducer, inside which a lifting and reversing shaft is installed.

3. The high-transmission-performance four-way shuttle in claim 2, wherein the lifting and reversing drive shaft is equipped with a lifting and reversing gearbox, and the lifting and reversing gearbox is connected to a cam swing arm.

4. The high-transmission-performance four-way shuttle in claim 3, wherein the cam swing arm is slidably connected to an X-direction guide slider, which is fixedly connected to the X-direction travel gearboxes and the Y-direction travel gearboxes.

5. The high-transmission-performance four-way shuttle in claim 4, wherein there are four Y-direction travel wheels and two Y-direction travel drive shafts.

6. The high-transmission-performance four-way shuttle in claim 4, wherein the Y-direction travel drive shaft has two ends, with each end installed with Y-direction travel wheels; the number of X-direction travel wheels is four.

7. The high-transmission-performance four-way shuttle in claim 4, wherein there are two X-direction travel drive shafts; each X-direction travel drive shaft has two ends; and each end is installed with X-direction travel wheels.

8. A method for operating a high-transmission-performance four-way shuttle, comprising:
S1: An X-direction travel servo motor planetary reducer is started, which drives an X-direction travel drive shaft through an X-direction travel gearbox; this causes the X-direction travel drive shaft to drive X-direction travel wheels to rotate and roll along an X-direction track, enabling the four-way shuttle to transport along the X-direction track;
S2: A lifting and reversing servo motor planetary reducer is started, which drives a lifting and reversing drive shaft through a lifting and reversing gearbox; this causes the lifting and reversing drive shaft to move a cam swing arm along an X-direction guide slider, lifting the cam swing arm; the cam swing arm then pushes X-direction travel wheels and Y-direction travel wheels into position, enabling Y-direction travel wheels to make contact with a Y-direction track;
S3: A Y-direction travel servo motor planetary reducer is started, which drives a Y-direction travel drive shaft through a Y-direction travel gearbox; this causes the Y-direction travel drive shaft to drive Y-direction travel wheels to rotate and roll along the Y-direction track, enabling the four-way shuttle to transport along the Y-direction track.
